(19) United States
(12) Patent Application Publication
(10) Pub. No.: US 2017/0074467 A1
(43) Pub. Date: Mar. 16, 2017

(54) METHODS AND APPARATUS FOR COLOR MIXING VIA ANGULAR LIGHT OUTPUT MODIFICATION

(71) Applicant: PHILIPS LIGHTING HOLDING B.V., Eindhoven (NL)

(72) Inventor: ERIC ANTHONY ROTH, TYNGSBORO, MA (US)

(21) Appl. No.: 15/309,302

(22) PCT Filed: Apr. 23, 2015
(86) PCT No.: PCT/IB2015/052962

§ 371 Date: Nov. 7, 2016

Related U.S. Application Data
(60) Provisional application No. 61/989,304, filed on May 6, 2014.

(51) Int. Cl. F21K 9/62; H05B 33/08; F21V 7/00

(52) U.S. Cl. CPC F21K 9/62; F21V 7/0091; H05B 33/0869; F21Y 2115/10

(57) ABSTRACT

A method (1000) for far field illumination using modified optical elements that normalize the angular distribution of light of different colors. A lighting unit (400) includes a plurality of light sources (410) emitting light of different colors, where each of the light sources is associated with a respective optical element (470, 480, 490). Each optical element is optimized to modify the angular distribution of light emitted from the light source such that the angular distribution of each of the light sources in the far field is substantially similar.

### TECHNICAL FIELD

The present invention is directed generally to far field illumination with uniform color light output. More particularly, various inventive methods and apparatus disclosed herein relate to far field illumination using an optimized optical element for each color in order to produce uniform color light output.

### BACKGROUND

Lighting systems with multiple light sources capable of producing light at different color temperatures are becoming more advanced and integrated both in the retail and home setting, and are increasingly being used to enhance a user's environment and to improve safety, productivity, enjoyment, and relaxation. For example, recent advances in light-emitting diodes (LED) technology have provided efficient full-spectrum lighting sources that enable a variety of lighting effects, including variations in color, intensity, and direction, for a wide variety of applications.

In lighting systems or fixtures that include one or more light sources, such as LED-based light sources, capable of producing light at different color temperatures, it is often necessary or desirable to accurately mix the light output of the different colored light sources prior to the light exiting the lighting fixture. Accurate mixing of light from different colored light sources reduces the presence of any chromatic abnormalities in the light output, and illuminates a target, such as a distant surface, in the far field with light having uniform brightness and color. A uniform far field light output is one that has consistent color and is evenly lit or has smooth transitioning from bright to dark. An observer of a uniform far field light output should not detect any individual colors in the light.

There are several known methods utilized to mix light from multiple LEDs into a uniform far field light output. Many lighting fixtures employ mixing chambers that emit the mixed light from a single optical element. To obtain a sufficiently narrow beam, such configurations may result in undesirably large mixing chambers that add to the cost of the lighting fixture and/or system. Mixing chambers are also inherently inefficient due to the multiple reflection losses within the chamber.

Lighting fixtures may also achieve far field color mixing through a diffusing element utilized over multiple LEDs, each having an individual optical element. Such configurations can reduce system efficiency by 10%, 20%, or more due to the added Fresnel reflection and absorption losses caused by the diffusing element. Further, the configuration adds to the overall expense of the lighting system and/or fixture. In order to obtain a narrow beam, the size of each individual optical element must be large enough to create a sufficiently narrow beam that allows the diffuser to mix the light by spreading that light over a larger area. This also increases the cost of the lighting system and/or lighting fixture by requiring larger optical elements and larger fixture size.

Accordingly, there is a need in the art for methods and lighting fixtures that mix the light emitted by LEDs of multiple colors for far field illumination with a light output that is uniform in color, without the need for a mixing chamber or a diffuser.

### SUMMARY

The present disclosure is directed to inventive methods and apparatus for creating a uniform far field light output from a mixture of different color LEDs, without requiring the use of a mixing chamber or a diffuser. In view of the foregoing, various embodiments and implementations are directed to a system with LEDs emitting different color light in which each LED color type has an optimized optical element to modify and normalize the angular distributions of that LED, resulting in a uniform far field illumination profile. Normalization of the angular distribution of each LED can be achieved by several different modifications, including modifying the inside sidewall of the optical element, modifying the outside cone or shape of the optical element, and a variety of other possible modifications.

For example, in some embodiments, a lighting fixture includes LEDs of different colors, such as red and green, to create a mixed far field light beam. One or both color LEDs utilize an optical element that has modified the angular distribution of the emitted light beam such that the far field light distribution of both color types is identical or nearly identical, and no color artifacts are detected. In some embodiments, for example, the angular distribution of red LEDs can be wider than the angular distribution of the green LEDs. Indeed, it is known that different LED materials result in different emission patterns. Accordingly, either the red LEDs must be adjusted to have a narrower angular distribution or the green LEDs are adjusted to have a wider angular distribution. Alternatively, both color types can be adjusted to produce beams having very specific, and identical, angular distributions.

Generally, in one aspect, a lighting unit is configured to emit a uniform far field light beam and includes a plurality of LED-based light sources emitting light of different colors, where the light emitted by each LED-based light source has an angular distribution; a plurality of optical elements each in in communication with a respective LED-based light source and arranged to modify the light emitted by that LED-based light source; where at least one of the optical elements is configured to modify the angular distribution of the light emitted from the LED-based light source, so that the modified angular distribution is substantially similar to the angular distribution of the light emitted by the remaining LED-based light sources.

In some embodiments, each of the optical elements is configured to modify the angular distribution of the light emitted from the LED-based light source such that all the modified angular distributions are substantially similar.

In some embodiments, the lighting unit includes a sensor configured to determine a characteristic of the emitted far field light beam. The determined characteristic can be utilized to modify the angular distribution of the light emitted from one or more of the LED-based light sources.

Generally, in one aspect, a lighting system is configured to emit a uniform far field light beam and includes a lighting unit having a plurality of LED-based light sources emitting light of different colors, and a plurality of optical elements each in communication with a respective LED-based light source and arranged to modify the light emitted by the respective LED-based light source, where the light emitted by each LED-based light source comprises an angular distribution. At least one of the optical elements is configured to modify the angular distribution of the light emitted from the respective LED-based light source such that the modified angular distribution is substantially similar to the angular distribution of the light emitted by the remaining LED-based light sources.

In some embodiments, each of the optical elements is configured to modify the angular distribution of the light emitted from the LED-based light source such that all the modified angular distributions are substantially similar.

In some embodiments, the lighting system includes a sensor that is configured to determine a characteristic of the emitted far field light beam. In some embodiments, the determined characteristic can be utilized to modify the angular distribution of the light emitted from one or more of the LED-based light sources.

Generally, in one aspect, the invention relates to a method for far field illumination, the method including the steps of providing a lighting unit having at least one LED-based light source in each of two or more colors, each of the LED-based light source associated with an optical element, where a light beam emitted by each of the LED-based light sources has an angular distribution, and normalizing the far field distribution of the light beam emitted by at least one of the two or more LED-based light sources.

In some embodiments, the step of normalizing the far field distribution of the light beam emitted by the two or more LED-based light sources includes the step of modifying the angular distribution of the emitted light beams.

In some embodiments, the step of normalizing the far field distribution of the light beam emitted by the two or more LED-based light sources includes the step of modifying a characteristic of the optical element associated with each light source. In some embodiments, the step of the modified characteristic is the shape of the optical element and/or the size of the optical element.

In some embodiments, the method also includes the step of characterizing the angular distribution of the light beams in the far field. Further, in some embodiments, the step of normalizing the far field distribution of the light beam emitted by the two or more LED-based light sources utilizes the characterized angular distribution of the light beam.

In some embodiments, the far field distribution of each of the emitted light beams is normalized such that the angular distribution of all of the emitted light beams is substantially similar.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers).

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

The term “light source” should be understood to refer to any one or more of a variety of radiation sources, including, but not limited to, LED-based sources (including one or more LEDs as defined above).

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a typical multi-color LED array;

FIG. 2 is a graph of normalized angular distribution of red, green, and blue LED light emitted by the multi-color LED array of FIG. 1;

FIGS. 3A and 3B are graphs of x-y color coordinates of a far field light beam emitted by the multi-color LED array of FIG. 1;

FIG. 4 is a schematic representation of a multi-color LED array and system in accordance with an embodiment of the invention;

FIG. 5 is a schematic representation of a multi-color LED array and system in accordance with an embodiment of the invention;

FIG. 6 is a schematic representation of an optical element in accordance with an embodiment of the invention;

FIG. 7 is a schematic representation of an optical element in accordance with an embodiment of the invention;

FIGS. 8A and 8B are graphs of x-y color coordinates of a far field light beam emitted by a multi-color LED array and system in accordance with an embodiment of the invention;

FIGS. 9A and 9B are schematic representations of a multi-color LED system in accordance with an embodiment of the invention; and

FIG. 10 is a flow chart of a method for far field illumination with uniform color output in accordance with an embodiment of the invention.

### DETAILED DESCRIPTION

It is often desirable to illuminate an environment or object with full-spectrum lighting sources that enable a variety of lighting effects, including variations in color, intensity, and direction, for a wide variety of applications. For example, many lighting systems and lighting fixtures utilize light sources having a variety of different color types or temperatures. To create a uniform far field light output without chromatic abnormalities, the light emitted from multiple different color types must be accurately mixed. Many lighting systems utilize mixing chambers or diffusers in order to mix the light from different color types. However, these mixing chambers and diffusers are bulky and inherently inefficient, and add expense to the lighting system.

More generally, Applicants have recognized and appreciated that it would be beneficial to normalize the angular distribution of one or more of several different LED color types in an array in order to produce a uniform far field light beam without the use of a mixing chamber or a diffuser.

In view of the foregoing, various embodiments and implementations are directed to a lighting system or fixture in which there are LED-based light sources of more than one color type or temperature, and one or more of the LED-based light sources has an optical element that is modified to adjust the angular distribution of the emitted light. In particular, the modified optical element normalizes the angular distribution of light emitted from LED-based light sources of different color types in order to create a uniform far field light beam.

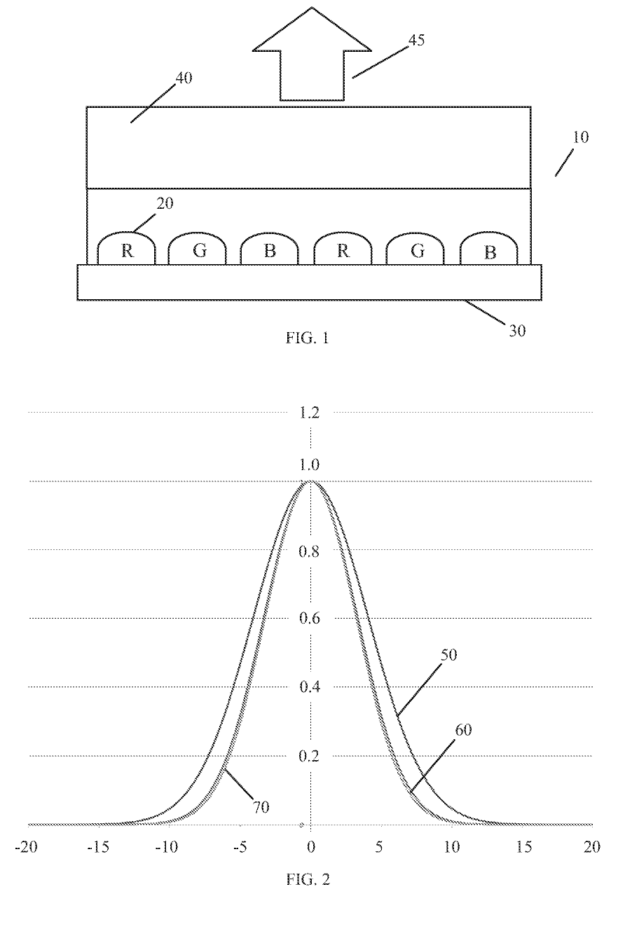

Referring to FIG. 1 is a lighting unit 10 according to typical LED-based lighting units as described above. Lighting unit 10 includes one or more LED-based light sources 20. Each LED-based light source 20 is a red, green, or blue LED, and the beams emitted from these light sources, when accurately mixed, forms white light beam 45. The LED-based light sources 20 are mounted on a carrier 30, such as a printed circuit board. Lighting unit 10 includes an optical element 40, such as a diffuser or mixing chamber, in which the red, green, and blue light is mixed to create white light beam 45.

FIG. 2 is a graph of a cross-section of the far field light output distribution of beam 45 being a mixture of light from a red LED light source 50, a green LED light source 60, and a blue LED light source 70, approximated using a cosⁿ curve for which the curve profiles are normalized to a maximum value of one. As the graph demonstrates, the angular distribution of the red, green, and blue light is not identical. For example, according to the graph in FIG. 2 the angular distribution of the light emitted from red LED light source 50 is wider than that of green LED light source 60 and blue LED light source 70, resulting in chromatic abnormalities such as uneven color mixing that may be visible in the far field light beam. For example, the chromatic abnormalities may be a red halo around the edges of light beam 45 in the far field.

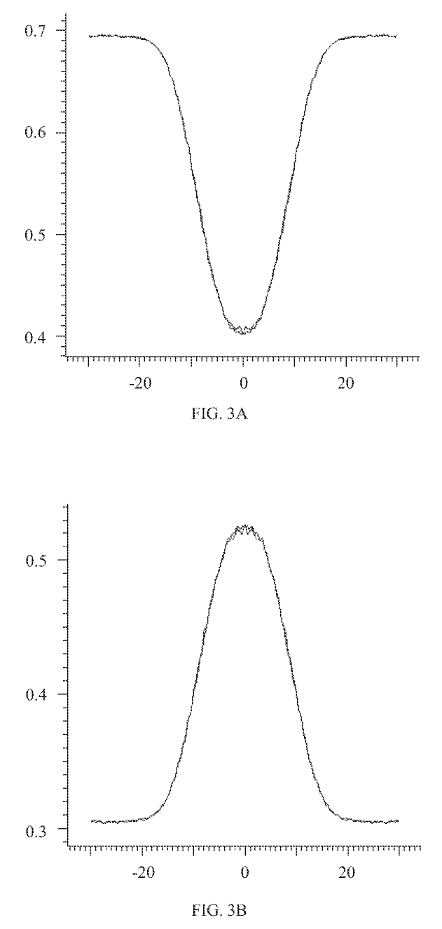

Color mixing of a far field light beam can be analyzed and plotted, for example, using a CIE (International Commission on Illumination) graph which describes the color of light along the x- and/or y-axis. FIG. 3A is a graph of the CIE x coordinate of a far field distribution of a sample circular light beam mixed from red and green LED-based light sources using a diffuser and/or mixing chamber, and FIG. 3B is a graph of the CIE y coordinate of a far field distribution of the same circular light beam. As the figures demonstrate, CIE color yellow (0.41, 0.53) is seen at 0,0 in the center of the circular light beam, and CIE color red (0.7, 0.3) is seen at the edge of the sample light beam beginning at approximately +/−17 degrees. Accordingly, FIGS. 3A and 3B show that a sample light beam mixed from red and green LED-based light sources can result in perceptible chromatic abnormalities along the x and/or y axis, rather than in an accurately mixed single color.

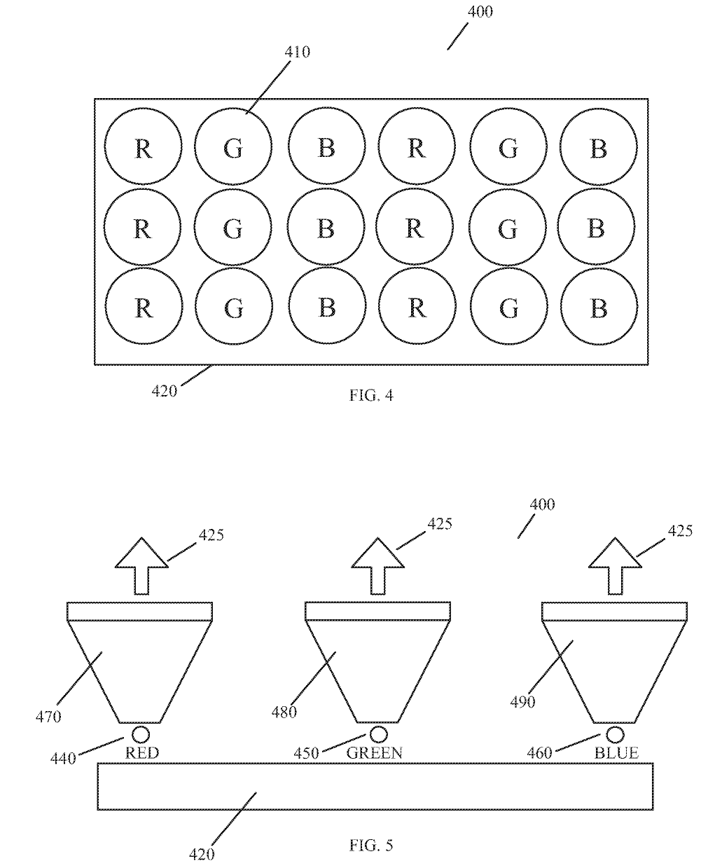

Referring to FIG. 4, in one embodiment, a lighting unit 400 is provided that includes one or more light sources 410 arranged in a two-dimensional 6×3 rectangular array, where one or more of the light sources is an LED-based light source. Each LED-based light source may have one or more LEDs. The light source can be driven to emit light of predetermined character (i.e., color intensity, color temperature) by one or more light source drivers. Many different numbers and various types of light sources (all LED-based light sources, LED-based and non-LED-based light sources alone or in combination, etc.) adapted to generate radiation of a variety of different colors may be employed in the lighting unit 400. According to the embodiment depicted in FIG. 4, each LED-based light source 410 is a red, green, or blue LED, and the beams emitted from these light sources, when accurately mixed, form white light. The LED-based light sources 410 can be mounted on a carrier 420, such as a printed circuit board, and lighting unit 400 can be any interior or exterior type of lighting fixture, including but not limited to a lamp, a floodlight, and many other types of lighting fixtures.

Lighting unit 400 may include a controller (not shown) that is configured or programmed to output one or more signals to drive the one or more light sources 410 and generate varying intensities and/or colors of light from the light sources. For example, the controller may be programmed or configured to generate a control signal for each light source to independently control the intensity and/or color of light generated by each light source, to control groups of light sources, or to control all light sources together. According to another aspect, the controller may control other dedicated circuitry such as a light source driver which in turn controls the light sources so as to vary their intensities. The controller can be or have, for example, a processor programmed using software to perform various functions discussed herein, and can be utilized in combination with a memory. Lighting unit 400 also includes a source of power, most typically AC power, although other power sources are possible including DC power sources, solar-based power sources, or mechanical-based power sources, among others.

Referring to FIG. 5, in one embodiment, lighting unit 400 is provided that includes red LED-based light source 440, green LED-based light source 450, and blue LED-based light source 460. Each of LED-based light sources 440, 450, and 460 may have one or more LEDs. Each of LED-based light sources 440, 450, and 460 emit a light beam 425 having a particular angular distribution. In order to achieve a uniform far field yellow light beam without color abnormalities, the red, green, and blue light is accurately mixed. To achieve accurate mixing such that the angular distribution of the light emitted from each of the LED-based light sources is substantially similar to all other angular distributions of the light sources, in one embodiment, each of LED-based light sources 440, 450, and 460 includes an optical element 470, 480, or 490, respectfully. One or more of optical elements 470, 480, and 490 can be modified to normalize the angular distribution of all light beams 425 emitted from the different light sources 440, 450, and 460. Indeed, there are many different ways to construct the surface or shape of an optical element, and often the surface is made from either a single curve or multiple curves that are joined to form a surface. These curves can be constructed based on one or more types of curves, including but not limited to Bezier curves, B-Spline curves, Polynomial curves, LeGrange Interpolated curves, and/or three-dimensional curves from any of this list.

There are many ways to modify an optical element to normalize the angular distribution of the light beam emitted from the LED-based light source, as described in detail herein. For example, any construction parameter that affects the surface of the optical element can be utilized for optimization. This includes not only the curve itself, but also the physical size of the optical element, the focal point location relative to the light source, and/or the orientation of the optical element, such as tip or tilt of the light source or the optical element in relation to each other or in relation to the target, among other modifiable elements. Individually or collectively, these modifications can change the angular distribution of the colored light beam emitted from the optical element.

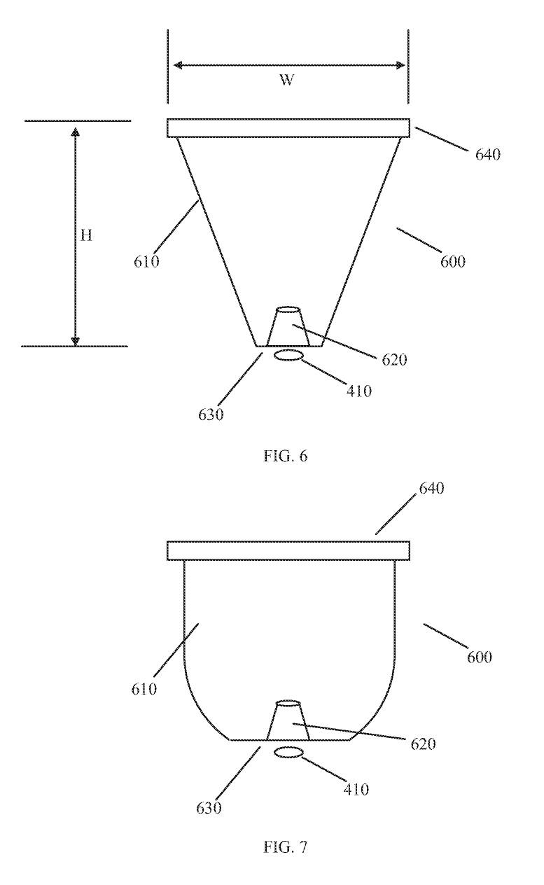

In reference to FIG. 6, in one embodiment, is an LED-based light source 410 with an optical element 600 that defines a specific emission angle for the light beam and/or a specific width of the emitted light beam, and which can be modified to normalize the angular distribution of the light beam emitted from the light source. For example, optical element 600 has a specific height H and width W, as depicted in FIG. 6. Either height H, width W, or both can be increased and/or decreased to adjust the emission width or angle of the emitted beam.

In addition to changing the size of the optical element, the shape of the optical element can be modified, as shown in FIG. 7. Narrowing, broadening, or otherwise adjusting the shape of the one or more sidewalls will modify the angular distribution of the emitted light. The optical element includes one or more sidewalls 610 with a predetermined shape, which may be related to the shape of the optical element. For example, the sidewall 610 may be curved in order to define the angular distribution of the light beam emitted from the optical element. The curvature of sidewall 610 can be modified, such as by increasing or decreasing the curvature, which will modify the emitted light beam. The material from which optical element is manufactured, and/or the material which lines the interior of sidewalls 610, will have a particular index of refraction that defines, in part, the angular distribution of the light beam emitted from the optical element. Accordingly, changing one or more of these materials will change the index of refraction and thus will impact the light beam's angular distribution. The sidewalls 610 and other components of the optical element 600 also have a predetermined surface roughness or texture that will impact the internal reflection and angular distribution of the light beam emitted from the optical element.

A change of the focal point of the LED-based light source 410 in the x-direction, y-direction, and/or the z-direction will modify the emitted beam. Similarly, the size of opening 630 between the light source 410 and the optical element 600 can be widened, narrowed, or otherwise modified to adapt the light beam. The size, shape, and curvature of the output surface 640 can also be modified in order to adapt the emitted light beam, as can the material from which surface 640 is manufactured. Indeed, any material through which light emitted from the light source passes can be configured to modify the angular distribution of the light, as refraction will occur when the light travels from one medium to another in the system. This refraction can be determined prior to manufacture based on known indices of refraction, or can be determined experimentally in the lighting system.

Optical element 600 can optionally include one or more other components that can be modified in order to modify the emitted beam. As one example, optical element 600 can comprise an internal central hyperbola or similar structure 620, the dimensions of which can be modified in order to modify the emitted beam. As an example, the shape of center hyperbola 620, including the height, width, and curve of the sides and/or opening of the structure, can be modified.

According to an embodiment, the optical element modification needed to normalize the angular distribution of the emitted light is determined using an algorithm. For example, the algorithm can utilize input such as the desired wavelength of the far field light beam, the distance to the far field, the possible modifications that can be made to the optical element, and/or one or more other inputs in order to calculate, estimate, or predict the modification needed to normalize the angular distribution of the light source to be adjusted. The algorithm can be used to design an optical element, or can be used to modify an existing lighting system using feedback from measurements of the angular distribution of the light sources in that lighting system.

Preferably, modifications of the optical element are made prior to or during the manufacture of the optical element, although according to one embodiment the optical element can be adjustable or interchangeable in the field. For example, the height, width, and/or shape of an optical element in a deployed lighting system can be adjustable in order to normalize the angular distribution of one or more color types based on estimates or on feedback within the lighting system. For example, a sensor external to or associated with the lighting system can detect the existence of a chromatic abnormality, such as a “red halo,” that requires modification of an optical element. The lighting system can be configured to automatically adjust the height, width, shape, and/or other parameters of an optical element in order to modify the angular distribution of one or more color types and ameliorate or resolve the detected chromatic abnormality. Modification of the optical element and resolution of the chromatic abnormality can be achieved through a single round of detection and adjustment, or can be achieved through several rounds of detection and adjustment. For example, the lighting system can determine that an angular distribution of one or more color types must be modified, and can direct the system to move one of the optical elements in one or more directions in order to adjust the focus of the emitted light beam. The optical element must be movable within the lighting system, which can be accomplished by one or more motors or similar mechanical components that can move the optical element in one or more directions.

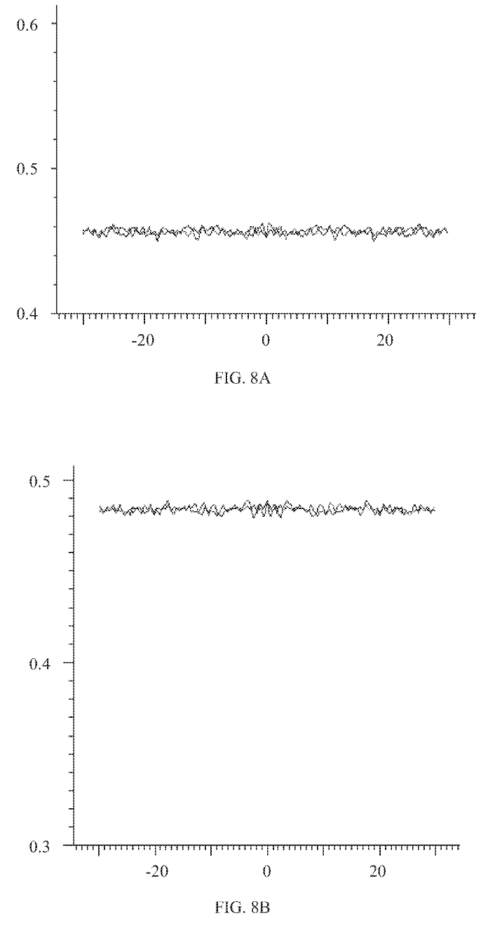

FIGS. 8A and 8B are CIE x and y graphs of the far field distribution of a light beam mixed from red and green LED-based light sources with modified optical elements that normalize the angular distribution of the two wavelengths. As shown by the graphs, especially when compared to the graphs in FIGS. 3A and 3B, the normalized angular distribution results in a uniform color being achieved in the far field. The uniform light distribution has a constant chromaticity from center to edge, meaning that the CIE x coordinate and CIE y coordinate are the same at each point.

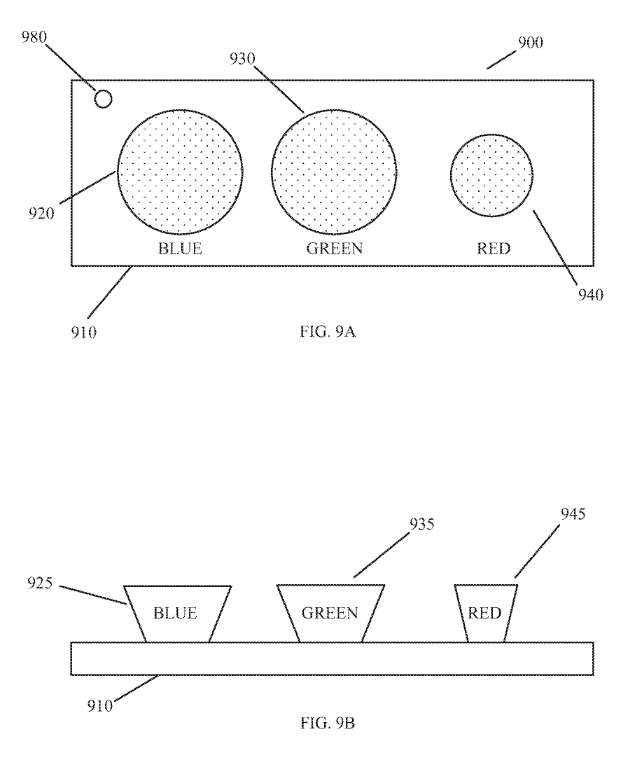

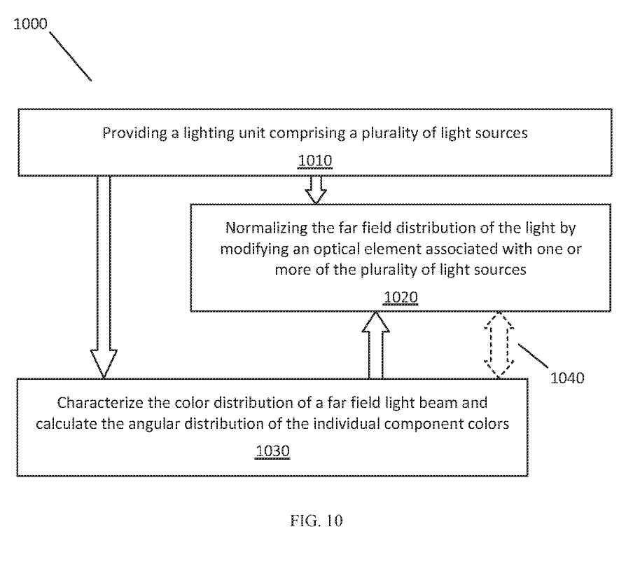

Referring to FIGS. 9A and 9B, in one embodiment, a lighting system 900 is provided that includes a blue LED-based light source 920, a green LED-based light source 930, and a red LED-based light source 940. Each of the LED-based light sources may have one or more LEDs. Each light source can be driven to emit light of predetermined character (i.e., color intensity, color temperature) by one or more light source drivers. Many different numbers and various types of light sources (all LED-based light sources, LED-based and non-LED-based light sources alone or in combination, etc.) adapted to generate radiation of a variety of different colors may be employed in the lighting system 900. According to the embodiment depicted in FIGS. 9 and 10, the beams emitted from the three light sources, when accurately mixed, form white light. Lighting system 900 can be any interior or exterior type of lighting system or fixture, including but not limited to a lamp, a floodlight, and many other types of lighting systems or fixtures.

LED-based light sources 920, 930, and 940 can be any of the embodiments described herein or otherwise envisioned, and can include any of the components of the lighting units described in conjunction with FIGS. 4-7, for example (e.g., one or more light source drivers, controllers, memory storage, power sources, sensors, etc.). For example, each of LED-based light sources 920, 930, and 940 can be associated with an optical element 925, 935, and 945. The LED-based light sources can be mounted on a carrier 910, such as a printed circuit board.

According to an embodiment, it is desirable to mix the different colored light beams emitted by LED-based light sources 920, 930, and 940 in order to produce a far field light beam of a single color, such as yellow, without chromatic abnormalities. In order to achieve a uniform far field light having a single color, one or more of the lighting elements associated with each of LED-based light sources 920, 930, and 940 can be modified or adjusted according to any of the embodiments described herein or otherwise envisioned. For example, in the embodiment depicted in FIG. 9, the width of the optical element associated with red light source 940 is reduced in order reduce the angular distribution of the light beam such that the angular distribution is normalized with the light beams emitted by blue light source 920 and green light source 930. This results in accurately mixed yellow light beam in the far field which is absent any significant chromatic abnormalities.

Although lighting system 900 is depicted in FIGS. 9A and 9B with blue, green, and red LED-based light sources, any combination of LEDs can be utilized and normalized. Additionally, lighting system 900 can include several or many more light sources. For example, the light sources can have a fixed color intensity and/or color temperature, or can be adjusted by a light source driver. Accordingly, in one embodiment, the optical element is manually or automatically adjustable in the field as the color intensity and/or color temperature of the LED-based light source is manually or automatically adjusted. For example, the shape of the optical element can be malleable or changeable either manually or by motors or other means. As just one example, liquid lenses can be utilized as the optical element in order to provide malleability to the lighting system. A photo sensor 980, or other sensor, can be utilized to detect changes in a color intensity and/or color temperature of the LED-based light source of the lighting system, to detect changes in the color distribution of the far field light beam, and/or to respond to programmed changes, among other detectable characteristics of the system or emitted light, and can result in adjustment of the optical element of one or more of the light sources based on that detection or feedback.

Referring to FIG. 10, a flow chart illustrating a method 1000 for far field illumination with uniform color output in accordance with an embodiment of the invention is disclosed. In step 1010, a lighting unit 400 is provided. Lighting unit 400 can be any of the embodiments described herein or otherwise envisioned, and can include any of the components of the lighting units or lighting systems described in conjunction with FIGS. 4 and 9, for example (e.g., modified optical elements, one or more light source drivers, controllers, memory storage, power sources, sensors, etc.). Lighting unit 400 includes one or more LED-based light sources 410, each of which may have one or more LEDs. Each light source 410 can be driven to emit light of predetermined character (i.e., color intensity, color temperature) by one or more light source drivers. Many different numbers and various types of light sources (all LED-based light sources, LED-based and non-LED-based light sources alone or in combination, etc.) adapted to generate radiation of a variety of different colors may be employed in the lighting unit 400.

In step 1020, one or more of the optical elements associated with one or more of light sources 410 in lighting unit 400 are modified in order to normalize the angular distribution of the colored light beam emitted by that light source. For example, the height, width, and/or shape of the optical element is modified, which changes the angular distribution of the light emitted from that optical element. Alternatively, other modifications of the optical element are possible in order to change the angular distribution of the light emitted from that optical element. The modification of the optical element can be made prior to or during manufacture, or can be made after the lighting unit is deployed or installed. For example, the optical element can be designed specifically to normalize the angular distribution of a specific light source. Alternatively, the optical element can be interchangeable or sufficiently malleable or adjustable to allow for changes to the shape or changes to other characteristics in order to adjust the angular distribution of the light beam emitted by the light source associated with that optical element. As just one example, the lighting system can include a standardized set of angular optical elements that can be interchangeable.

Alternatively, in step 1030, the color distribution of a far field light beam created by an installed lighting unit or lighting system is characterized. For example, the far field light distribution of the lighting unit or lighting system can be measured using methods and sensors known in the art. Once the far field light distribution of the lighting unit or lighting system is measured or otherwise characterized, it can be analyzed to detect any color aberrations or other chromatic abnormalities. If a chromatic aberration is detected, the lighting unit, lighting system, and/or sensor system can calculate, estimate, or otherwise determine the change or modification required to normalize the aberrant color profile and ameliorate or remedy the aberration. For example, if the unit, system, and/or sensor detects a halo effect of a first color, the optical element of the LED-based light source emitting that color is targeted for modification. According to one embodiment, the lighting unit, lighting system, and/or light sensor calculates the angular distribution necessary to ameliorate or remedy the aberration, and utilizes that information to determine the change or modification to the optical element needed to effectuate the calculated angular distribution. Alternatively, the optical element is manually or automatically adjusted and the resulting change to the angular distribution and/or the far field light distribution is monitored to determine when the optical distribution is achieved and no further modification is necessary. This process can be performed once, or can be iterative as denoted by arrow 1040.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A lighting unit configured to emit a uniform far field light beam, the lighting unit comprising:
a plurality of LED-based light sources emitting light of different colors, wherein each LED-based light source includes one or more LEDs, and wherein the light emitted by each LED-based light source comprises an angular distribution;
a plurality of optical elements, each of said plurality of optical elements in communication with a respective one of said plurality of LED-based light sources and arranged to modify the light emitted by said LED-based light source;
wherein at least one of said optical elements in communication with a respective LED-based light source emitting light of a given color is configured to modify an angular distribution of the light emitted from the respective LED-based light source such that the modified angular distribution is substantially similar to angular distributions of light emitted by one or more other LED-based light sources of the plurality of LED-based light sources that emit light of one or more colors that are different than the given color.

2. The lighting unit of claim 1, wherein each of said optical elements is configured to modify the angular distribution of the light emitted from the LED-based light sources such that all the angular distributions are substantially similar.

3. The lighting unit of claim 1, further comprising a sensor configured to determine a characteristic of the emitted far field light beam.

4. The lighting unit of claim 3, wherein the determined characteristic of the emitted far field light beam is utilized to modify the angular distribution of the light emitted from one or more of said plurality of LED-based light sources.

5. A lighting system configured to emit a uniform far field light beam, the lighting system comprising:
a lighting unit comprising a plurality of LED-based light sources emitting light of different colors, wherein each LED-based light source includes one or more LEDs, and wherein and a plurality of optical elements each in communication with a respective LED-based light source and arranged to modify light emitted by the respective LED-based light source, wherein the light emitted by each LED-based light source comprises an angular distribution;
wherein at least one of said plurality of optical elements in communication with a respective LED-based light source emitting light of a given color is configured to modify an angular distribution of the light emitted from the respective LED-based light source such that the modified angular distribution is substantially similar to angular distribution of a light emitted by one or more other LED-based light sources of the plurality of LED-based light sources that emit light of one or more colors that are different than the given color.

6. The lighting system of claim 5, wherein all of said plurality of optical elements is configured to modify the angular distribution of the light emitted from the respective LED-based light source such that all the modified angular distributions are substantially similar.

7. The lighting system of claim 5, further comprising a sensor configured to determine a characteristic of the emitted far field light beam.

8. The lighting system of claim 7, wherein the determined characteristic of the emitted far field light beam is utilized to modify the angular distribution of the light emitted from one or more of said plurality of LED-based light sources.

9. A method for far field illumination, the method comprising the steps of:
providing a lighting unit comprising a plurality of LED-based light sources emitting light of different properties, each of said plurality of LED-based light sources associated with a respective optical element, and each LED-based light source including one or more LEDs, wherein a light beam emitted by each LED-based light source comprises an angular distribution; and
normalizing a far field distribution of a light beam emitted by at least one of the plurality of LED-based light sources with far field distributions of one or more light beams emitted by one or more others of the plurality of LED-based light sources;
wherein the light beam emitted by the at least one of the plurality of LED-based light sources has a given property that is different than properties of the one or more light beams emitted by the one or more others of the plurality of LED-based light sources.

10. The method of claim 9, wherein the step of normalizing the far field distribution of the light beam emitted by the at least one of the plurality of LED-based light sources comprises the step of modifying the angular distribution of said emitted light beam.

11. The method of claim 9, wherein the step of normalizing the far field distribution of the light beam emitted by the at least one of the plurality of LED-based light sources comprises the step of modifying a characteristic of the optical element associated with the at least one light source.

12. The method of claim 11, wherein said characteristic is the shape of the optical element.

13. The method of claim 11, wherein said characteristic is the size of the optical element.

14. The method of claim 11, further comprising the step of characterizing the angular distribution of at least one of said light beams in the far field.

15. The method of claim 14, wherein the step of normalizing the far field distribution of the light beam emitted by at least one of the plurality of LED-based light sources utilizes the characterized angular distribution of said light beam.

16. The method of claim 9, wherein the far field distribution of each of said emitted light beams is normalized such that the angular distribution of all of the emitted light beams is substantially similar.
